(19) United States
(12) Patent Application Publication
(10) Pub. No.: US 2009/0046157 A1
(43) Pub. Date: Feb. 19, 2009

(54) COMBINED WIDE-ANGLE/ZOOM CAMERA FOR LICENSE PLATE IDENTIFICATION

(76) Inventors: Andrew Cilia, McKinney, TX (US); Robert V. Vanman, McKinney, TX (US)

Correspondence Address: WINSTEAD PC, P.O. BOX 50784, DALLAS, TX, 75201, US

(21) Appl. No.: 12/188,273

(22) Filed: Aug. 8, 2008

Related U.S. Application Data
(60) Provisional application No. 60/955,442, filed on Aug. 13, 2007.

(51) Int. Cl. H04N 5/225; H04N 5/232

(52) U.S. Cl. 348/207.1; 348/347; 348/E05.024; 348/E05.042

(57) ABSTRACT

A system for recognizing and identifying at least one object of interest. The system includes a computer, a first camera, electrically coupled to the computer, the first camera having a wide-angle lens, and a second camera electrically coupled to the computer, the second camera operative to focus on coordinates supplied from the computer. The computer detects the at least one object of interest within a field of view of the first camera, and directs the second camera to focus on the at least one object of interest.

### CROSS REFERENCE TO RELATED APPLICATIONS

The present application claims priority to, and incorporates by reference, for any purpose, the entire disclosure of U.S. Provisional Patent Application Ser. No. 60/955,442, filed Aug. 13, 2008, entitled COMBINED WIDE-ANGLE/ZOOM CAMERA FOR LICENSE PLATE IDENTIFICATION.

### BACKGROUND

1. Technical Field

This application relates generally to recognition of license plates and other objects of interest for use in law enforcement, and, in particular, to vehicle-mounted license-plate-recognition systems simultaneously using a wide-angle camera and a zoom camera.

2. History of the Related Art

The ability to effectively recognize and identify license plates is a vital law-enforcement tool used, for example, in the identification of stolen vehicles or individuals with felony warrants. Most commercially available license-plate-recognition systems employ a fixed-position camera and require the license plate to appear in a field of view of the camera. The limitations of a fixed-position camera, and the consequential reliance on the license plate coming into the camera's field of view, greatly reduce the number of license plates that can be identified, and significantly limit the evidence-gathering capability of the system.

### SUMMARY OF THE INVENTION

A system for recognizing and identifying at least one object of interest. The system includes a computer, a first camera electrically coupled to the computer, the first camera having a wide-angle lens, and a second camera electrically coupled to the computer, the second camera operative to focus on coordinates supplied from the computer. The computer detects the at least one object of interest within a field of view of the first camera and directs the second camera to focus on the at least one object of interest.

A method for recognizing and identifying vehicular license plates. The method includes receiving an image from a first camera, detecting at least one object of interest within a field of view of the first camera, and determining a location coordinates of the at least one object of interest. The method further includes focusing a second camera to the location coordinates and capturing, via the second camera, an image of the at least one object of interest.

### BRIEF DESCRIPTION OF THE DRAWINGS

FIG. 1 is a schematic diagram of a license-plate-identification system;

FIG. 2 is a flow diagram depicting a method for license plate identification; and

FIG. 3 is a schematic diagram of a license-plate-identification system.

### DETAILED DESCRIPTION OF ILLUSTRATIVE EMBODIMENTS OF THE INVENTION

Various embodiments of the present invention will now be described more fully with reference to the accompanying drawings. The invention may, however, be embodied in many different forms and should not be construed as limited to the embodiments set forth herein; rather, the embodiments are provided so that this disclosure will be thorough and complete, and will fully convey the scope of the invention to those skilled in the art. The above summary of the invention is not intended to represent each embodiment or every aspect of the present invention.

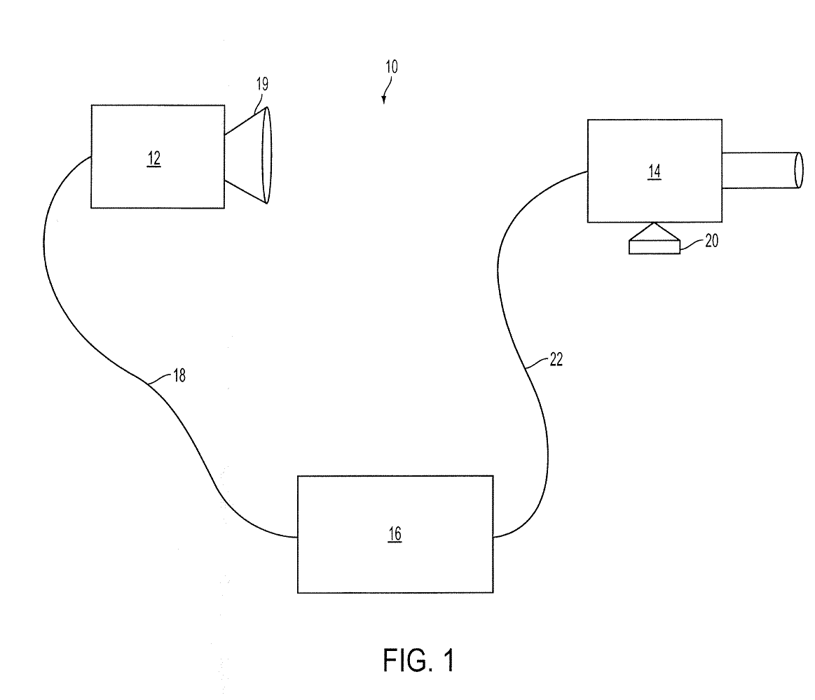

Referring first to FIG. 1, there is shown a schematic diagram of a license-plate identification system 10. As shown in FIG. 1, the system 10 includes a wide-angle camera 12, a zoom camera 14, and a computer 16. The wide-angle camera 12 is equipped with a wide-angle lens 19 and is electrically connected to the computer 16 via a cable 18. The wide-angle camera 12 and the computer 16 in combination are capable of determining coordinates of license plates, or other objects of interest within a field of view of the wide-angle camera 12. The zoom camera 14 is mounted on a pan/tilt mechanism 20 and is electrically connected to the computer 16 via a cable 22. The zoom camera 14 is capable of focusing on the coordinates provided by the computer 16. The zoom camera 14 may be any appropriate camera, but is typically an infrared camera with active infrared illumination so as to provide good acuity under a variety of lighting conditions. The computer 16 may be, for example, a stand-alone unit, but is typically integrated within the system 10. Although the wide-angle camera 12 and the zoom camera 14 are depicted by way of example as being connected to the computer 16 via cables 18 and 22, it is also contemplated that the wide-angle camera 12 and the zoom camera 14 could also be connected to the computer 16 by way of a wireless connection.

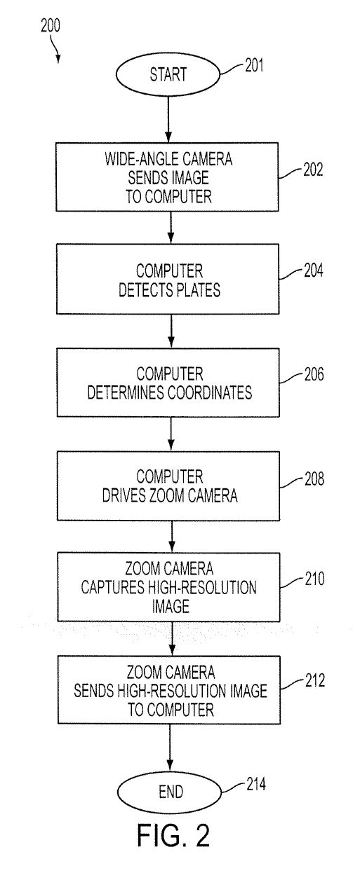

Referring next to FIG. 2, there is shown a flow diagram depicting a process for license plate identification. During operation, as best illustrated in FIG. 2, the process 200 begins at step 201. At step 202, the wide-angle camera 12 sends at least one image to the computer 16. Based on the at least one image received from the wide-angle camera 12, the computer 16 detects license plates or other objects of interest that have entered the field of view of the wide-angle camera 12, as shown in step 204. The computer 16 next determines coordinates of the license plates or other objects of interest, as shown in step 206. At step 208, the computer 16 drives the zoom camera 14 via the cable 22 and the pan/tilt mechanism 20 to the determined coordinates. At step 210, the zoom camera captures a high-resolution image at the determined coordinates. At step 212, the zoom camera sends the captured image to the computer 16. The computer 16 may then perform various operations on the received high-resolution image such as, for example, storage of the image or an optical character-recognition function. It is further contemplated that the image captured in step 210 may be either a high-resolution image, or a standard low-resolution image. The process 200 ends at step 214

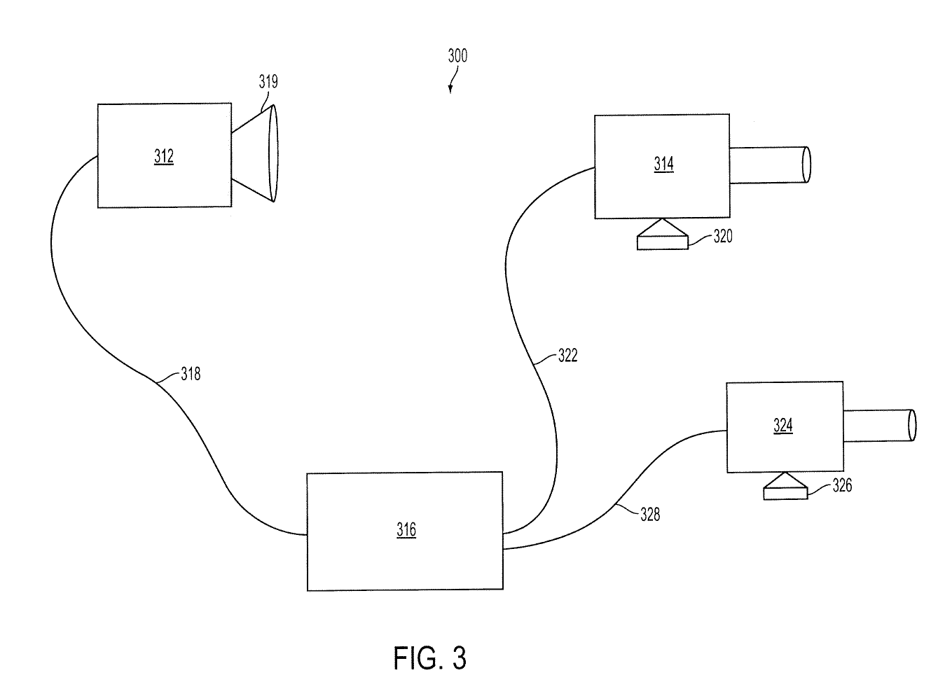

Referring next to FIG. 3, there is shown a schematic diagram of an alternative embodiment of a license plate identification system 300. As shown in FIG. 3, the system 300 includes a wide-angle camera 312 and a computer 316 as substantially described hereinabove. The wide-angle camera 312 is equipped with a wide-angle lens 319, and is electrically connected to the computer 316 via a cable 318. As described hereinabove, the wide-angle camera 312 and the computer 316 in combination are capable of determining coordinates of license plates, or other objects of interest within a field of view of the wide-angle camera 312. As shown in FIG. 3, the system 300 includes a first zoom camera 314 electrically connected to the computer 316 via a cable 322, and a second zoom camera 324 electrically connected to the computer by way of a cable 328. Both the first and the second zoom cameras 314 and 324 are mounted on pan/tilt mechanisms 320 and 326. The first and second zoom cameras 314 and 324 are each capable of focusing on the coordinates provided by the computer 316 thereby allowing the system 300 the added capability of simultaneously focusing on more than one license plate or other objects of interest. The first and second zoom camera 314 and 324 may be any appropriate camera, but is typically an infrared camera with active infrared illumination so as to provide good acuity under a variety of lighting conditions. The computer 316 may be, for example, a stand-alone unit, but is typically integrated within the system 300. Although the wide-angle camera 312 and the first and second zoom camera 314 and 324 are depicted by way of example as being connected to the computer 316 via cables 318, 322, and 328, it is also contemplated that the wide-angle camera 312 and the first and second zoom camera 314 and 324 could also be connected to the computer 16 by way of a wireless connection.

Although various embodiments of the method and system of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth herein.

What is claimed is:

1. A system for recognizing and identifying at least one object of interest, the system comprising:
a computer;
a first camera, electrically coupled to the computer, the first camera having a wide-angle lens;
a second camera electrically coupled to the computer, the second camera operative to focus on coordinates supplied from the computer; and
wherein the computer detects the at least one object of interest within a field of view of the first camera, and directs the second camera to focus on the at least one object of interest.

2. The system of claim 1, wherein the first camera, the second camera, and the computer are mounted in a vehicle.

3. The system of claim 1, wherein the second camera is mounted on a pan/tilt mechanism.

4. The system of claim 1, wherein the second camera is capable of active infrared illumination.

5. The system of claim 1, wherein the computer performs optical character recognition.

6. The system of claim 1, wherein the second camera transmits high-resolution images to the computer.

7. The system of claim 1, further comprising at least a third camera electrically coupled to the computer.

8. The system of claim 7, wherein the computer detects a second object of interest within the field of view of the first camera, and directs the third camera to focus on the second object of interest.

9. The system of claim 1, wherein the computer stores high-resolution images.

10. The system of claim 1, wherein the computer provides coordinates of the at least one object of interest to the second camera.

11. The system of claim 1, wherein the at least one object of interest is a vehicular license plate.

12. The system of claim 1, wherein the first and second cameras are wirelessly connected to the computer.

13. The system of claim 1, wherein the first and second cameras are connected to the computer by way of a plurality of cables.

14. A method for recognizing and identifying vehicular license plates, the method comprising:
receiving an image from a first camera;
detecting at least one object of interest within a field of view of the first camera;
determining a location coordinates of the at least one object of interest;
focusing a second camera to the location coordinates; and
capturing, via the second camera, an image of the at least one object of interest.

15. The method of claim 14, wherein the first camera is a wide-angle camera.

16. The method of claim 14, wherein the second camera is a zoom camera.

17. The method of claim 14, wherein the second camera is mounted on a pan/tilt mechanism.

18. The method of claim 14, wherein the step of focusing the second camera is accomplished by way of a computer electrically coupled to the first camera and the second camera.

19. The method of claim 14, further comprising detecting, via a computer, the at least one object of interest within the field of view of the first camera.

20. The method of claim 14, further comprising detecting, via a computer, the coordinates of the license plate.

21. The method of claim 14, further comprising transmitting, via a computer, the coordinates to the second camera.

22. The method of claim 14, further comprising performing, via a computer, optical character recognition.

23. The method of claim 14, wherein the second camera is capable of active infrared illumination.

24. The method of claim 14, further comprising transmitting a high-resolution image to a computer.

25. The method of claim 14, wherein the at least one object of interest is a vehicular license plate.

26. The method of claim 14, further comprising:
detecting at least a second object of interest within a field of view of the first camera;
determining a location coordinates of the second object of interest;
driving a third camera to the location coordinates; and
capturing, via the third camera, an image of the second object of interest.

27. The method of claim 14, wherein the image is a high-resolution image.
